(19) United States
(12) Patent Application Publication
(10) Pub. No.: US 2015/0231592 A1
(43) Pub. Date: Aug. 20, 2015

(54) DUAL PHASE COLUMN MEMBRANE PROTEIN MICRO-REACTOR AND USE THEREOF

(71) Applicant: DALIAN INSTITUTE OF CHEMICAL PHYSICS, CHINESE ACADEMY OF SCIENCES, Liaoning (CN)

(72) Inventors: Lihua Zhang, Dalian (CN); Qun Zhao, Dalian (CN); Kaiguang Yang, Dalian (CN); Yu Liang, Dalian (CN); Zhen Liang, Dalian (CN); Yukui Zhang, Dalian (CN)

(21) Appl. No.: 14/429,670

(22) PCT Filed: Jun. 7, 2013
(86) PCT No.: PCT/CN2013/076942

§ 371 Date: Mar. 19, 2015

(30) Foreign Application Priority Data
Sep. 20, 2012 (CN) 201210349969.0

(51) Int. Cl. B01J 19/00

(52) U.S. Cl. CPC B01J 19/0093; B01J 2219/0079; B01J 2219/00849

(57) ABSTRACT

The present invention relates to a biphasic microreactor for membrane proteins pretreatment comprising cation exchange and anion exchange materials packed in sequence in a container as stationary phase, where membrane proteins capture, pH adjustment, reduction, alkylation and tryptic digestion processed in situ. Thus the microreactor has advantages of high recovery, ease of operation, high efficiency and high throughput.

### FIELD OF THE INVENTION

The present invention relates to a biphasic microreactor for membrane proteins pretreatment, combining membrane proteins enrichment, pH adjustment, reduction, alkylation and digestion in situ, which is also compatible with subsequent separation and detection.

### BACKGROUND OF THE INVENTION

Cellular membranes function as a natural barrier and a communication interface between intracellular compartments, cells, and their environments, physically separating the cells from surrounding environment and maintaining the stability of intracellular environment. And membrane proteins play unique roles in material transport, cell recognition and immune response, signal transduction and regulation, as well as energy transduction. What's more, membrane proteins constitute up to ⅓ of the total genome in a range of eukaryotes and 70% of the drug targets in study. However, membrane proteins analysis remains challenging due to the highly hydrophobic nature, resulting in poor solubility in aqueous buffer and digestion efficiency.

Formic acid (FA) is an efficient solubilizing agent for membrane proteins, and pepsin or cyanogen bromide (CNBr) is used for subsequent proteolytic digestion. However, CNBr is highly toxic and the fragments of CNBr cleavages are too large for mass spectrometer (MS) detection. The low cleavage specificity of pepsin results in a dramatic increase in the theoretical peptide list, which not only is time-consuming for data searching but also causes high false discovery rate (FDR), ultimately leading to poor protein identification. As the prevalent enzyme choice in current proteomic analysis, trypsin exhibits excellent specific cleavage behavior for protein digestion and generates peptides with suitable mass (500-3000 Da) for MS analysis. Therefore, it is significant for membrane proteins analysis to combine the FA solubilization and tryptic digestion.

Martinou et al. (Cruz, S. D., Xenarios, I., Langridge, J., Vilbois, F., Parone, P. A., Martinou, J. C., J. Biol. Chem. 2003, 42, 41566-41571.) demonstrated a strategy by adding ammonium bicarbonate to adjust sample which was solubilized with FA to pH 8, compatible with subsequent trypsin digestion. However, it is not an ideal method for membrane proteins analysis for: 1) it is inconvenient for operation; 2) the concentration of membrane proteins is seriously diluted; 3) membrane proteins are precipitated during solvent replacement process; 4) sample loss is serious since the process is performed in an Eppendorf tube; 5) it's difficult to couple with online liquid chromatography (LC)-MS/MS analysis.

### BRIEF SUMMARY OF THE INVENTION

To solve above problems, the aim of this invention is to establish a biphasic microreactor for membrane proteins pretreatment. With the membrane proteins are loaded and enriched on microreactor, the environment can be adjusted from low pH for solubilization to high pH for tryptic digestion with easiness, high recovery, and without sample dilution. What's more, the whole sample preparation procedure is in situ performed in the microreactor, without an extra-column process and can be further directly automatic operated.

To achieve the above purpose, the technical protocol as follow is adopted:

1. Preparation of biphasic microreactor for membrane proteins pretreatment: the biphasic microreactor was prepared by packing strong cation exchange (SCX) and strong anion exchange (SAX) particles in sequence as stationary phase in a capillary with an on-column monolithic frit.

2. pH adjustment: after membrane proteins solubilized with 90% formic acid (FA) and loaded onto the biphasic microreactor, 1-50 mM ammonium bicarbonate (ABC) is flushed into the reactor to adjust the microenvironment from low pH to high pH with easiness and high recovery, which is benefit for subsequent reduction, alkylation and digestion.

### ADVANTAGES OF THE INVENTION

1. Easiness to prepare the biphasic microreactor. A biphasic microreactor can be prepared in situ by packing or synthesizing two kinds of ion exchange materials with complementary retention behavior in sequence in a container.

2. Convenience and efficiency for operation. It is convenient to adjust the pH environment by using buffer solution with corresponding pH to wash the microreactor which is packed with two kinds of ion exchange materials with complementary retention behavior of proteins. What's more, the pH value can be detected with pH test paper in real time.

3. High recovery. The protein sample loss caused by pH adjustment is avoided since two kinds of ion exchange materials with complementary retention behavior of proteins are used (FIG. 3). In addition, the whole sample preparation process is performed in situ in the reactor, avoiding the sample loss caused by sample transfer and adsorption to tube (FIG. 4).

4. Excellent dissolving ability of formic acid (FA) for membrane proteins and trypsin digestion is combined without sample dilution by using biphasic microreactor. Membrane proteins are solubilized with 90% FA (v/v) first, and the membrane proteins are loaded onto the microreactor after diluted to 1% FA (v/v). Then, the microreactor is washed with ammonium bicarbonate (ABC) to adjust the pH to 7-8, which is compatible with subsequent reduction, alkylation and tryptic digestion processes.

5. High throughput. The whole sample preparation can be finished in 2-4 h without transfer, lyophilization or any other processes.

### BRIEF DESCRIPTION OF THE SEVERAL VIEWS OF THE DRAWINGS

FIG. 1 shows a structure of biphasic microreactor. 1: flow outlet; 2: hydrophilic frit; 3: strong anion exchange material; 4: strong cation exchange material; 5: flow inlet;

FIG. 2 shows a flowchart for sample analysis using biphasic microreactor. 7: membrane protein pellets; 8: solubilization by formic acid (FA); 9: replaced to pH 7-8, reduction, alkylation and tryptic digestion.

FIG. 3 shows an SDS-PAGE image of effluents in sample loading, and pH replacement steps with biphasic microreactor. Lane 1: marker; Lane 2: a mixture of BSA, Myo and Cyt C; Line 3: flow-through fraction in sample loading step with biphasic microreactor; Line 4: flow-through fraction in sample loading step with SCX microreactor; Line 5: unretained fraction in pH replacement step with biphasic microreactor; Line 6: unretained fraction in pH replacement step with SCX microreactor.

FIG. 4 shows a sample recovery evaluated by the peak area of reverse phase (RP) desalt. A: Standard curve of reverse phase desalt peak area plotted by the mixture of BSA, Myo, Cyt C tryptic digestions as the sample; B: The recovery of the whole sample preparation with biphasic microreactor obtained by 4 μg of the mixture of BSA, Myo, Cyt C as the sample.

### DESCRIPTION OF THE PREFERRED EMBODIMENTS

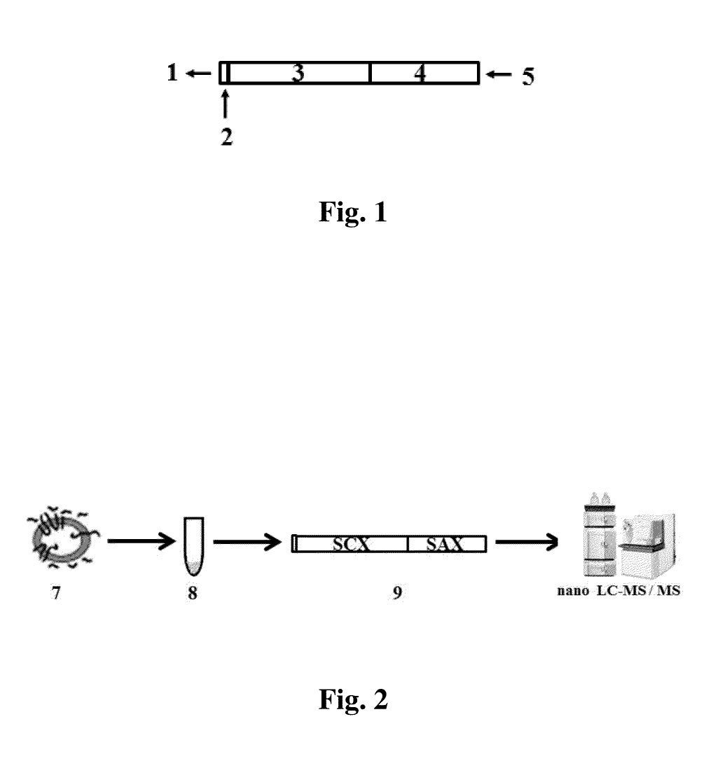

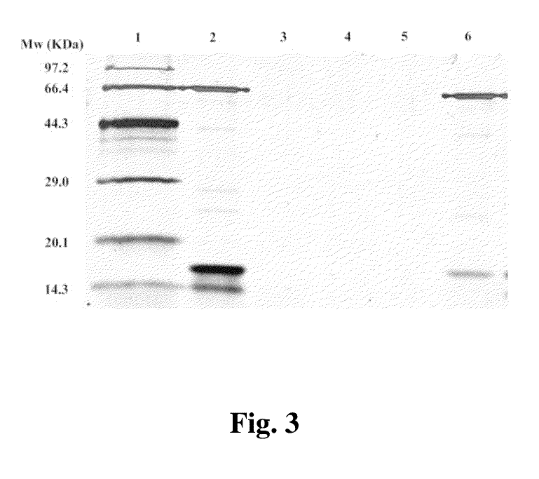

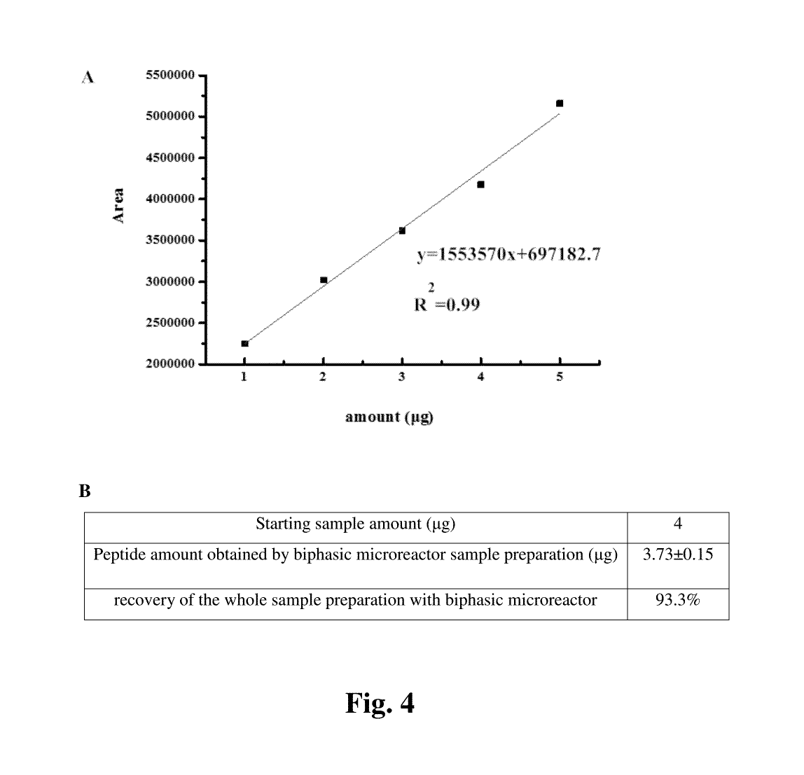

1. Preparation of biphasic microreactor for membrane proteins pretreatment: hydrophilic frit 2 was synthesized in situ in capillaries (200 μm i.d.) (FIG. 1) as following: (1) Pretreatment of capillary. Capillaries were activated with 1M NaOH, water, 1M HCl, water and methanol, respectively. After capillaries were dried under N₂ at 70° C., 50% (v/v) solution of γ-MAPS in methanol was filled and with both ends sealed with silica gel, capillaries were incubated in dark for 24 h at room temperature. Finally, methanol was used to flush the unreacted solution in capillaries, which were further dried by N₂ prior to use. (2) Preparation of hydrophilic frit. Polymerization solution, containing 0.1500 g PEGDA, 0.0015 g AIBN, 0.3500 g propyl alcohol, was purged with N₂ for 30 s to expel the oxygen dissolved therein, and then filled into the capillaries about 5 cm. After both ends of capillaries were sealed with silica gel, the capillaries were put into the water bath at 50° C. for 24 h. Then, strong anion exchange (SCX) 3 (TOSOH, TSK-GEL SuperQ-5PW, 10 μm, 1000 Å) and strong cation exchange (SAX) 4 (TOSOH, TSK-GEL SP-5PW, 10 μm, 1000 Å) materials were packed in sequence about 2 cm in column, respectively.

2. Evaluate the performance of the biphasic microreactor: The mixture of BSA, Myo and Cyt C was solubilized with 90% formic acid (FA) (v/v), followed by heating at 90° C. for 10 min for denaturation. After the sample was diluted to 1% FA (v/v) to accommodate the dissociation condition of SCX column, the sample was loaded onto the SCX segment, then the biphasic microreactor was washed with 5 mM ammonium bicarbonate (ABC) to adjust pH to 7.5. Subsequently, 100 mM dithiothreitol (DTT) was incubated for 30 min at room temperature for reduction, followed by loading 10 mM iodoacetamide (IAA) for the alkylation at room temperature for 30 min in the dark. Finally, 2 mg/mL trypsin dissolved in 5 mM ABC was quickly loaded, and the microreactor was sealed with 5 mM ABC, followed by being incubated at 37° C. for 1-2 h. After protein pretreatment, the microreactor was directly connected with a C18 capillary separation column (75 μm i.d., 17 cm, 2 cm tip, Phenomenex, Luna C18(2), 5 μm, 100 Å) for 1D-liquid chromatography-mass spectrometry (LC-MS/MS) analysis.

For the control experiment, the in-solution digestion was also performed for the mixture of BSA, Myo and Cyt C. Briefly, BSA, Myo and Cyt C were individually dissolved in 1 mL ABC (50 mM, pH 8) buffer, followed by mixing with equal mass to a final protein concentration of 1 mg/mL. Then the sample was denatured at 90° C. for 10 min, reduced with 10 mM DTT at 56° C. for 2 h, and alkylated with 25 mM IAA at room temperature for 30 min in the dark. After that, the sample was digested with trypsin with enzyme/protein ratio as 1:40 (m/m) at 37° C. for 12 h. Finally, a final concentration of 1% (v/v) FA was added into the solution to terminate the reaction.

The efficiency of protein reduction, alkylation (Table 1) and digestion (Table 2) are comparable according to the results obtained by the biphasic microreactor and in-solution preparation methods.

3. Analysis of membrane proteins extracted from rat cerebellums pretreated by biphasic microreactor: The membrane proteins extracted from rat cerebellums was solubilized with 90% formic acid (FA) (v/v), followed by heating at 90° C. for 10 min for denaturation. After the sample was diluted to 1% FA (v/v) and loaded onto the SCX segment, the biphasic microreactor was washed with 5 mM ABC to adjust pH to 7.5. Subsequently, 100 mM DTT was incubated for 30 min at room temperature for reduction, followed by 10 mM iodoacetamide 30 min at room temperature for reduction, followed by loading 10 mM IAA for alkylation at room temperature for 30 min in the dark. Finally, 2 mg/mL trypsin dissolved in 5 mM ABC was quickly loaded and the microreactor was incubated at 37° C. for 1-2 h. After protein pretreatment, the microreactor was directly connected with a SCX column and C18 capillary separation column (75 μm i.d., 17 cm, 2 cm tip, Phenomenex, Luna C18(2), 5 μm, 100 Å) for 2D-LC-MS/MS analysis.

4. Data analysis: The obtained spectra were searched against database and false discovery rate control. In total, 975 proteins were identified, corresponding to 3841 peptides. Among them, 416 membrane proteins were identified, occupying 43% of the total protein groups. In addition, 103 transmembrane peptides were also identified.

TABLE 1
The identification results of BSA with reduction
and alkylation pretreatment by in-solution
method and biphasic microreactor method.
Pretreatment with biphasic microreactor method

K.VASLRETYGDMADCCEK.Q
K.VASLRETYGDMADCCEKQEPER.N
R.ETYGDMADCCEK.Q
R.ETYGDMADCCEKQEPER.N
R.RHPYFYAPELLYYANKYNGVFQECCQAEDK.G
K.YNGVFQECCQAEDK.G
K.YNGVFQECCQAEDKGACLLPK.I
K.VHKECCHGDLLECADDRADLAK.Y
K.ECCHGDLLECADDR.A
K.ECCHGDLLECADDRADLAK.Y
K.LKECCDKPLLEK.S
K.EYEATLEECCAK.D
K.EYEATLEECCAKDDPHACYSTVFDK.L
R.CCTKPESER.M
K.CCTESLVNR.R
R.CCTKPESERMPCTEDYLSLILNR.L
K.TVMENFVAFVDKCCAADDKEACFAVEGPK.L
K.CCAADDKEACFAVEGPK.L

Pretreatment with in-solution method

R.ETYGDMADCCEK.Q
K.YNGVFQECCQAEDK.G
K.YNGVFQECCQAEDKGACLLPK.I
K.VHKECCHGDLLECADDR.A
K.VHKECCHGDLLECADDRADLAK.Y
K.ECCHGDLLECADDR.A
K.ECCHGDLLECADDRADLAK.Y
K.EYEATLEECCAK.D
K.EYEATLEECCAKDDPHACYSTVFDK.L
R.CCTKPESER.M
K.CCTESLVNR.R
K.CCAADDKEACFAVEGPK.L

TABLE 2
Sequence coverage of proteins obtained with samples treated
by biphasic microreactor and in-solution methods

Sequence Coverages

| | Biphasic microreator method | In-solution method |
|---|---|---|
| BSA | 81% | 80% |
| Myo | 94% | 94% |
| Cyt C | 65% | 63% |

1. A biphasic microreactor for membrane proteins pretreatment, wherein: the microreactor comprises a hollow container, where the cation exchange and anion exchange materials or anion exchange and cation exchange materials are packed in sequence, with monolithic frit made in one end or two ends of the hollow container; and the hollow container is a container with shape of cylinder, cone or disk, while the internal diameter is 50 μm-5 cm.

2. The biphasic microreactor for membrane proteins pretreatment according to claim 1, wherein: the container is 20-1000 μl pipette tips, 1-20 ml solid phase extraction pipet, 1-20 ml syringe needle, capillary with internal diameter of 50-500 μm or syringe filter cavity.

3. The biphasic microreactor for membrane proteins pretreatment according to claim 1, wherein: the plunger is a monolithic frit synthesized in situ or sieve plate with pore size of 3 nm-20 μm.

4. The biphasic microreactor for membrane proteins pretreatment according to claim 1, wherein: the container is packed with cation exchange and anion exchange materials; and the cation exchange material is strong cation exchange material containing sulfate and/or phosphate group, or weak cation exchange material containing carboxylic group; the anion exchange material is strong anion exchange material containing quaternary amine group, or weak anion exchange material containing secondary and/or tertiary amine group; and the materials are particle or monolithic materials.

5. The biphasic microreactor for membrane proteins pretreatment according to claim 1, wherein: the use of cation and anion exchange materials can be combination of: strong cation and strong anion, strong cation and weak anion, weak cation and strong anion, weak cation and weak anion exchange materials.

6. The application of biphasic microreactor for membrane proteins pretreatment according to claim 1, wherein:
1) Cation and anion exchange materials or anion and cation exchange materials are packed in sequence in container with a plunger at one edge; the shape of container is cylinder, cone or disk, and the internal diameter is 50 μm-5 cm;
2) Membrane proteins are dissolved in acid solution (pH 1-7) or basic solution (pH 7-14) containing 1-30% (m/v or v/v) surfactant or detergent, and loaded onto the microreactor;
3) The microreactor was washed with basic solution (pH 7-14) or acid solution (pH 1-7) to adjust the pH microenvironment;
4) After being reduced with reductant, alkylated with alkylating reagent, the proteins are digested in the basic solution (pH 7-14) or acid solution (pH 1-7);
5) After digestion, the peptides are eluted from microreactor with 200-2000 mM salt solution; then, the elution is collected, separated with liquid phase chromatography and detected with mass spectrometer, ultraviolet or fluorescent detectors.

7. The application according to claim 6, wherein: the acid solution (pH 1-7) is formic acid (FA), trifluoroacetic acid (TFA), trichloroacetic acid (TCA) or acetic acid solution;
The surfactant are sodium dodecyl sulfate (SDS), sodium deoxycholate (SDC), Triton X-100, chaps, RapiGest SF or NP-40d; the detergent are urea, thiourea or guanidine hydrochloride;
The basic solution (pH 7-14) are ammonium bicarbonate (ABC), phosphate or Tris (hydroxymethyl) aminomethane (Tris) buffer solution;
The solvent for membrane proteins solubilization can be acid solution (pH 1-7) or basic solution (pH 7-14);
While the capture process is under acid condition, the packing sequence was: the solution flows from cation exchange material section to anion exchange material section;
While the capture process is under basic condition, the packing sequence was: the solution flows from anion exchange material section to cation exchange material section.

8. The application according to claim 6, wherein: while the capture process is under acid condition, 1-100 mM basic solution (pH 7-14) is used to adjust pH environment; while the capture process is under basic condition, 1-100 mM acid solution (pH 1-7) is used to adjust pH environment.

9. The application according to claim 6, wherein: the reductant can be dithiothreitol (DTT), trichloroethyl phosphate (TCEP) or β-mercaptoethanol with concentrations between 1-200 mM;
The alkylating reagent can be iodoacetic acid or iodoacetamide with concentrations between 1-200 mM;
When the proteins are digested in basic solution (pH 7-14), the enzyme can be one or mixture of trypsin, Arg-C, Lys-C, chymotrypsin; the ratio of enzyme to protein is between 1/100-1/10;
When the proteins are digested in acid solution (pH 1-7), the enzyme can be pepsin or cyanogen bromide (CNBr) with enzyme/protein between 1/100-1/10; the salt solution can be ammonium bicarbonate, NaCl, ammonium acetate, phosphate or Tris buffer solution.

10. The application according to claim 6, wherein: after membrane proteins being loaded onto the microreactor, the subsequent reduction, alkylation and enzymolysis steps are processed in situ.

11. The biphasic microreactor for membrane proteins pretreatment according to claim 4, wherein: the use of cation and anion exchange materials can be combination of: strong cation and strong anion, strong cation and weak anion, weak cation and strong anion, weak cation and weak anion exchange materials.
